(19) United States
(12) Patent Application Publication
(10) Pub. No.: US 2001/0042134 A1
(43) Pub. Date: Nov. 15, 2001

(54) Computer communication network

(76) Inventor: Osamu Ichiyoshi, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/847,443

(22) Filed: May 3, 2001

(30) Foreign Application Priority Data
May 11, 2000 (JP) 2000-139117

(51) Int. Cl. G06F 15/16

(52) U.S. Cl. 709/245

(57) ABSTRACT

A computer communication network, wherein a computer is specified by an address defined in a telephone network. In the computer communication network, the address defined in the telephone network may be used in place of an Internet protocol address. In the computer communication network, the address may be a telephone number. In the computer communication network, the address may be a number in the Integrated Service Digital Network. The computer communication network may comprise: an address server for correlatively storing the address defined in the telephone network and a name corresponding to the address, wherein the computer on a originating side comprises: means for inquiring of the address server about the address corresponding to a name of a computer on a terminating side; and means for calling the address received from the address server.

### BACKGROUND OF THE INVENTION

1. Field of the Invention

The present invention relates to a computer communication network using a communication network such as a telephone network (PSTN: Public Switched Telephone Network).

2. Description of the Prior Art.

Conventionally, in Japan, personal computer communication networks have developed. In a personal computer communication network, a subscriber connects a personal computer installed in her/his house to a connection point provided by a personal computer system common carrier (provider) through a telephone network to receive services. This communication network configuration is shown in FIG. 1.

In FIG. 1, reference numeral 1 denotes a user, and reference numeral 2 denotes a communication network such as a telephone network or the like. Reference numeral 21 denotes a connection point between the user and the communication network, and also denotes a subscriber exchanger in the communication network. Reference numeral 5 denotes a server provided by a personal computer common carrier. Reference numeral 22 denotes a connection point between the server 5 and the telephone network 2. The user connects her/his personal computer to the server 5 through the telephone network 2 to receive a personal computer communication service. In this case, as the telephone network, a leased line for data communication is used. The user 1 makes call incoming to the connection point 22 connected with the server 5 through a subscriber exchanger 21, checks whether connection can be performed on the basis of a response from the server 5, and then starts communication.

On the other hand, in the United States, the Internet has been developed. The Internet is characterized as follows. That is the Internet is independent of the telephone network, and communication on the Internet is basically performed using packets called datagrams. Briefly speaking, distribution of a signal to a destination is performed by a router every packet. Connection networks between routers form a backbone communication network of the Internet, and a signal reaches a target communication network through a large number of routers. When the signal reaches the target communication network, a packet is distributed to a target terminal (called a “host”) through a local area network (LAN) controlled by the router of the target communication network.

The configuration of the Internet is shown in FIG. 2.

In FIG. 2, reference numerals 51 to 54 denote routers. Routers A to D (51 to 54) are connected to one another to form a backbone (communication network 6. The routers A to D themselves constitute local communication networks, i.e., so-called LANs, respectively. The router A 51 constitutes a LAN 61 and has users A1 to A3 connected thereto, the router B 52 constitutes a LAN 62 and has users B1 to B3 connected thereto, the router C 53 constitutes a WAN or a LAN 63 and has users C1 to C3 connected thereto, and the router D 52 constitutes a LAN 64 and has users D1 to D3 connected thereto. A user terminal connected to a LAN is called a host. Communication between users in each LAN is performed without a router. When communication between hosts belonging to different LAN must be performed, connection is performed by packet communication between routers. Owing to that routers perform connection among different communication networks, the Internet (World Wide Web) serving as a single global communication network is constituted as a whole.

The router constitutes a communication network which is independent of a telephone network and transfers each IP packet to a host designated by a designation IP address of a length of 4 bytes (32 bits) or 16 bytes (128 bits). For this reason, a routing table for establishing a route from an originating IP address to the destination IP address is required. However, each router has to always communicate with an adjacent router to update the routing table. On the other hand, since it is inconvenient for people to directly treat an IP address constituted of only numerals, a name called a domain name system (DNS) which can be easily understood by people is used. Therefore, a domain name must be converted into an IP address. For this reason, a DNS server (indicated by 55) is arranged for each communication network. When connection to a certain first destination is to be performed for the first time, a host inquires of the DNS server 55 about a destination IP address corresponding to the domain name input by a user, and sets the destination IP address returned from the DNS server 55 in the header of an IP packet to transmit the IP packet to the Internet.

As is apparent from the above description, it is the first problem that the Internet has a low used rate of lines and requires complex processes.

The first reason is that, as described above, routers must always exchange pieces of routing information to one another to update respective routing tables. The second reason is that the TCP is required. The reason why the TCP is required is that an IP packet may be lost in the middle of a communication path, and IP packets may reach a destination in an incorrect order because of routing performed independently for each IP packet. The third reason is the nature of packet communication that signals may collide each other in addition to the possibility that signals may be lost.

It is the second problem that the range of information transmission is limited in the conventional personal computer communication. This is because personal computer communication is a service provided by a specific common carrier, and is an essentially closed system.

It is the third problem that a conventional computer communication network has a problem in the security of information of subscribers. This is because, in the Internet and personal computer communication, information originally owned by subscribers is accumulated in a database provided by the common carrier, and data once transmitted to the database is placed at a place which is not managed by subscribers. Therefore, since a common carrier keeps information from subscribers, the common carrier has a heavy responsibility for the security of the information.

It is the fourth problem that The Internet has come to be short of IP addresses. This is because Internet addresses have a horizontal configuration which is free from a hierarchical structure.

The horizontal configuration of the Internet is an advantage of the Internet which has been developed as an open system. The horizontal configuration, however, makes a destination distributing operation cumbersome, and the operation of a router becomes complex. Each router always exchanges pieces of routing information with an adjacent router to update its routing table. Therefore, even when there is no IP packet to be transmitted between hosts, pieces of information must be always exchanged among routers, and the cost increases.

### SUMMARY OF THE INVENTION

In order to overcome the aforementioned disadvantages, the present invention has been made and accordingly, has an object to implement a computer communication network which has a high used rate, and is inexpensive, safety, and open.

According to the present invention, there is provided a computer communication network, wherein a computer is specified by an address defined in a telephone network.

In the computer communication network, the address defined in the telephone network may be used in place of an Internet protocol address.

In the computer communication network, the address may be a telephone number.

In the computer communication network, the address may be a number in the Integrated Service Digital Network.

The computer communication network may comprise: an address server for correlatively storing the address defined in the telephone network and a name corresponding to the address, wherein the computer on a originating side comprises: means for inquiring of the address server about the address corresponding to a name of a computer on a terminating side; and means for calling the address received from the address server.

In the computer communication network, any of the names in the computer communication network may not be duplicated nor the same as any of domain names in the Internet.

In the computer communication network, the address server may be an exchanger.

The essential constituent elements of the present invention will be briefly described below. Each subscriber prepares a homepage in a computer installed in her/his house, and an address in a telephone network, e.g., a telephone number or an ISDN number, is set as the address of the homepage of the subscriber. A common carrier of the telephone network provides an address server for widely notifying the address of the homepage in the telephone network to the world. As the address server, the same server as a DNS server of the Internet is used.

A computer is connected to a subscriber's terminal in the telephone network, and the computer stores the homepage. The address number of the homepage is designated by an address defined in the telephone network, and user terminals are directly connected to each other through a communication network using the address defined in the telephone network to establish communication.

A domain name system similar to that of the Internet is used. Therefore, the homepage is generally published with a name which can be easily understood by users for the sake of convenience of the users. As in the case of the Internet, a computer accesses a homepage with an address of the homepage defined in a telephone network which corresponds to the name of the homepage and which is obtained from the domain name system.

The operation of the system according to the present invention will be described below.

A case in which general subscriber A who subscribes to a general telephone service or an ISDN establishes homepage to start computer communication will be described below.

The subscriber A installs a computer in her/his house, and stores homepage A described in HTML or the like in the computer. The subscriber A applies a self address to a telephone carrier. More specifically, the subscriber applies a name which correctly expresses the characteristic feature of the self homepage and a number (e.g., a telephone number or an ISDN number) in a telephone network to the telephone carrier. The carrier confirms that the applied name is not the same as any of the names held by all the other subscribers in the system of the present invention nor the same as any of the domain names in the Internet. If it is confirmed that the applied name is not the same as any of the names nor any of the domain names, an operator of the system according to the present invention registers the applied name with an address server and informs, the subscriber A that the applied name has been registered. The address server has a function which returns a number corresponding to a received name and defined in a telephone network, and the address server is basically the same as a DNS server of the Internet.

Next, an operation performed when general Internet user X accesses the homepage A will be described below. It is assumed that the Internet user X uses a search engine to obtain the name of the homepage A. By using the name, the Internet user X instructs her/his computer to access the homepage A.

The computer X inquires of the address server about an address corresponding to the name of the homepage A and defined by a telephone network. In response to this inquiry, the address server returns the address of the homepage A in the telephone network. Subsequently, the computer X calls the address of the homepage A in the telephone network returned from the address server to secure a telephone line for accessing the homepage A. When completing the access to the homepage A, the user disconnects the telephone line. The computer X stores the relationship between the name of the homepage A and the number in the telephone network after disconnection of the telephone line when finish using. When the computer X accesses the homepage A next time, the inquiry to the address server is omitted.

A communication network to be used is not limited to only a telephone network. When a packet communication network is used, the above-mentioned line setting and disconnecting operations are not necessary. In the packet communication network, the same communication as that in the Internet can be performed except for a position where a hemepage is established.

### BRIEF DESCRIPTION OF THE DRAWINGS

FIG. 1 is a diagram showing the network configuration of conventional personal computer communication;

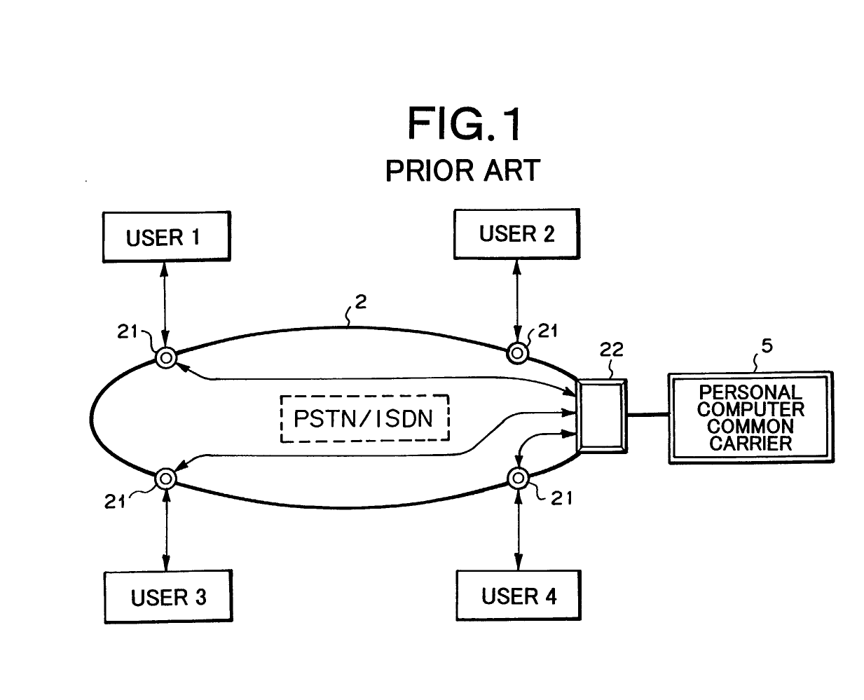

FIG. 2 is a diagram showing the conventional network configuration of the Internet; and

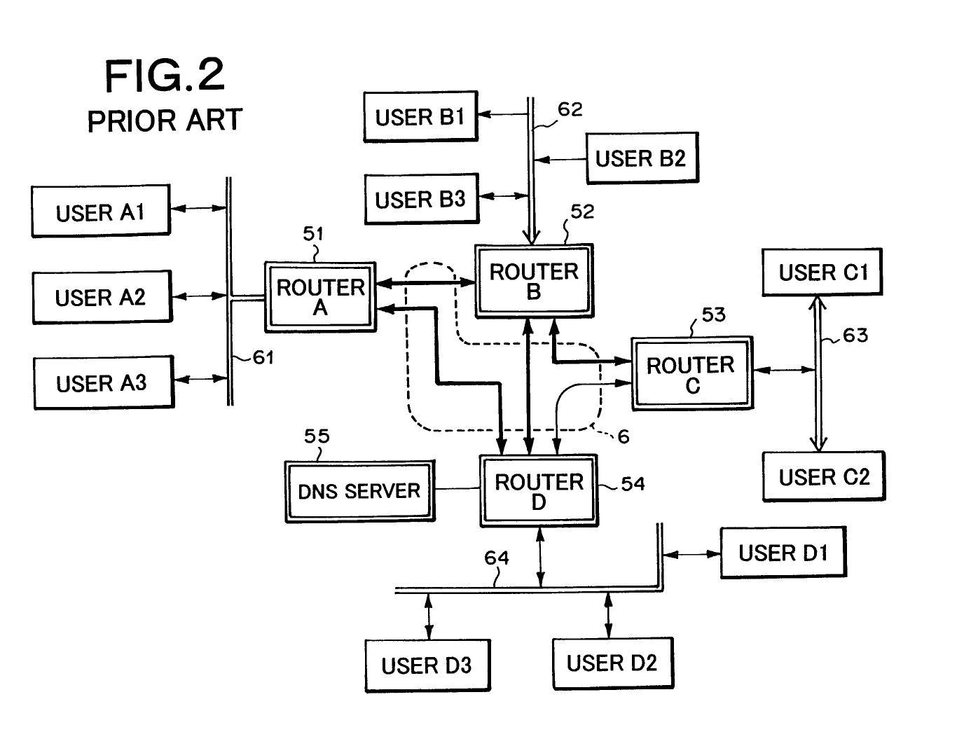

FIG. 3 is a diagram showing the configuration of a computer communication network according to the present invention;

### DETAILED DESCRIPTION OF PREFERRED EMBODIMENTS

An embodiment of the present invention will be described below with reference to the accompanying drawings.

(1) Description of Configuration

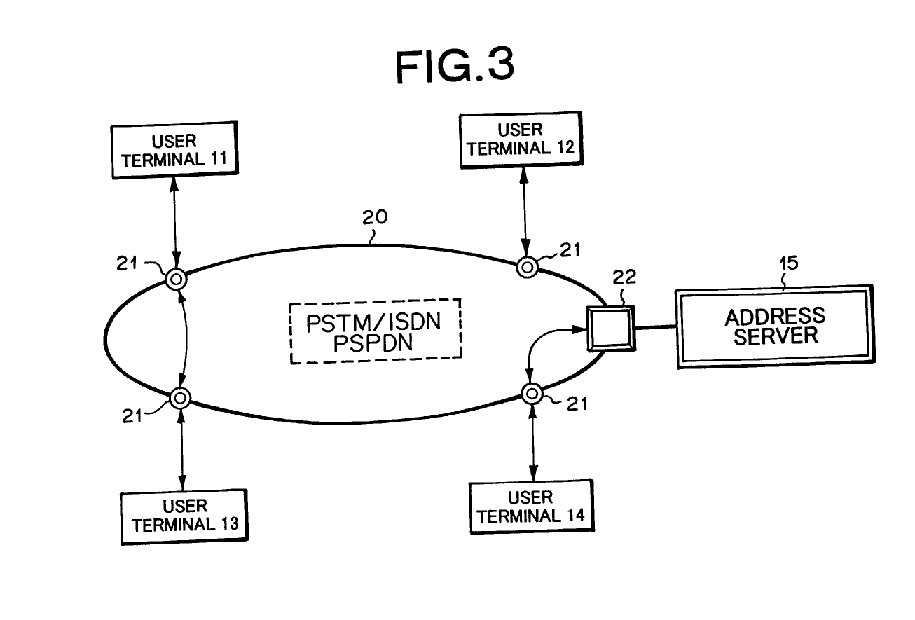

Referring to FIG. 3, it is apparent that the embodiment of the present invention is a communication network directly using a conventional public switched telephone network (PSTN) and having a very simple configuration. The PSTN includes not only a public telephone line network including a subscriber's line, access line, a repeating circuit or the like for connecting exchangers to each other but also an ISDN. In addition, the PSTN also includes a recent mobile communication network using portable telephones.

In FIG. 3, reference numerals 11 to 14 denote user terminals; 20, a communication network; and 15, an address server. Reference numeral 21 denotes connection points between each of the user terminals 11 to 14 of subscribers and the communication network 20. In the telephone network, the connection point corresponds to a subscriber's exchanger. Reference numeral 22 denotes a connection point between the address server 15 and the communication network 20.

Here, each of the user terminals 11 to 14 comprises a computer and peripheral devices. Each computer incorporates a modem for a communication line therein, and comprises a storage device such as a hard drive, a CD-ROM drive, or an MO drive for storing a protocol program according to the present invention being based on the TCP/IP, an operating system (OS), application programs, and the like. In addition, the communication network 20 is a communication network such as a public telephone line, an ISDN, or the like.

(2) Description of Operation

An operation of a network shown in FIG. 3 will be described below. In FIG. 3, it is assumed that the user terminal 11 and the user terminal 13 have already been connected to each other and are communicating with each other. A user of the user terminal 14 designates the name of a designation to be connected for the first time, and instruct the user terminal 14 (since the user and the computer used by the user are paired with each other, the user is identified as the computer) to start communication. The user terminal 14 transmits the name to the address server 15, and the address server 15 returns the address corresponding to the name and defined in the telephone network.

In this step, the line between the user terminal 14 and the address server 15 need not to be a telephone line, nor a packet line, but may be the Internet for convenience. When the user terminal obtains the address, the user terminal 14 establishes a connection with a destination user terminal 12 using a normal telephone line connection operation to perform communication with the destination user terminal.

When data is to be transmitted from the user terminal 14 to the user terminal 12, the user terminal 14 is hooked up to transmits a calling signal, and replied with the dial tone of the response from the subscriber's exchanger 21, and the user terminal 14 dials the telephone number of the user terminal 12. Alternatively, the user terminal 14 inquires of the address server 15 about the telephone number of the user terminal 12 in the telephone network. When the user terminal 14 receives a notice of the address, the user terminal 14 dials the telephone number of the user terminal 12.

The subscriber's exchanger 21 transmits a selection signal corresponding to a dial destination to the user terminal 12. When the user terminal 12 is busy, an busy-back tone is transmitted to the user terminal 14 to notify the user terminal 14 that data transmission fails. When the user terminal 12 is not busy and is hooked up, the user terminal 14 immediately transmits data to the user terminal 12. In this case, bidirectionality is secured by the function of an exchanger of a public line network. In the present Internet, for data transmission for a response, data is not returned through the same line in data transmission for response, and another line may be employed by using the destination address of a header added to a packet as an index. Therefore, the communication according to the present invention is considerably different from the communication in the recent Internet.

When data transmission is to be ended, an on-hook operation may be performed. In the subscriber's exchanger 21, a communication line is disconnected by the on-hook operation.

As is apparent from the above description, according to the system of the present invention, E-mail or file transfer is similarly performed. Another function such as the function of an electronic conference can also be provided. In order to realize the function of the electronic conference, a certain homepage serves as a host, so that a member may use a service such as a bulletin board system provided by the homepage.

In the above embodiment, the example in which the address server 15 responds to inquiry from the user terminal 14 has been described. However, when the name of a destination is output from the user terminal 14, the subscriber's exchanger 21 may inquire of the address server 15 about an address corresponding to the name and defined in a telephone network, and the subscriber's exchanger 21 may acquire the address defined in a telephone network from the address server 15. After the subscriber's exchanger 21 acquires the address defined in the telephone network, the subscriber's exchanger 21 calls the destination user terminal 12 having the address while repeating an calling signal. When a response signal is generated from the computer of the destination user terminal 12, the response signal reaches to the user terminal 14 through a plurality of subscriber's exchangers, so that a speech line is established as a linked state. Thereafter, the user terminal 14 transmits data to the destination user terminal 12. When the destination user terminal 12 has a homepage, the user terminal 14 can obtain the information of the homepage Thereafter, when the user terminal 11 disconnects the speech line by the on-hook function, the respective subscriber's exchangers 21 generate an acknowledge signal and a disconnection signal to disconnect the line.

As described above, when a telephone communication network according to this embodiment is formed, by using excellent equipment which is similar to a telephone line in the stability, credibility, reliability, and security, data communication similar to that of the telephone system can be performed.

In the embodiment, a wired public telephone network has been mainly described. However, not only fixed computers, but also mobile personal computers or PDAs (Personal Digital Assistants) can be connected to lines by using an address defined by a wireless telephone network as an index. In addition, an address server for converting the name of a user terminal into an address defined in a telephone network may be included in the user terminal, or may be arranged in a subscriber's exchanger. The address server may also be arranged in a repeating exchanger for bundling a predetermined number of subscriber's exchangers.

According to the present invention, a conventional public telephone network serves as a computer communication network, and, by using a system which effectively uses the reliability and security of the computer communication network and infrastructure, users are directly connected to each other to perform communication. Since the system which is indispensable for a conventional Internet communication method and which is provided by a personal computer common carrier or an Internet service provider (ISP) is not necessary, the cost of an operation can be reduced, and a computer communication network can be realized by a very simple configuration.

Since the system according to the present invention directly uses a communication network such as a conventional telephone network, versatile and open natures of the PSTN can be directly inherited. For this reason, an information network which has high security of information and which is very versatile and open can be realized.

Provided information is placed in a computer installed in the house of an information provider, and is perfectly managed. A reference to a user who accesses the information can be recognized by information provided by a communication network every time the user accesses the information. In addition, since the system according to the present invention very naturally coexists with the conventional personal computer communication and the Internet, various services can be given to clients, and extremely various types of system can be constituted.

What is claimed is:

1. A computer communication network, wherein a computer is specified by an address defined in a telephone network.

2. A computer communication network according to claim 1, wherein the address defined in the telephone network is used in place of an Internet protocol address.

3. A computer communication network according to claim 1, wherein the address is a telephone number.

4. A computer communication network according to claim 1, wherein the address is a number in the Integrated Service Digital Network.

5. A computer communication network according to claim 1, comprising:
an address server for correlatively storing the address defined in the telephone network and a name corresponding to the address,
wherein the computer on a originating side comprises:
means for inquiring of the address server about the address corresponding to a name of a computer on a terminating side; and
means for calling the address received from the address server.

6. A computer communication network according to claim 5, wherein any of the names in the computer communication network is not duplicated nor the same as any of domain names in the Internet.

7. A computer communication network according to claim 5, wherein the address server is an exchanger.
